(19) United States
(12) Patent Application Publication
(10) Pub. No.: US 2006/0018633 A1
(43) Pub. Date: Jan. 26, 2006

(54) Digital video storage system and related method of storing digital video data

(76) Inventors: Ching-Yu Tsai, Taipei Hsien (TW); Chi-Hui Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/710,594

(22) Filed: Jul. 22, 2004

(51) Int. Cl. H04N 5/781

(52) U.S. Cl. 386/125; 386/126

(57) ABSTRACT

A digital video (DV) storage system comprises an interface module receiving an incoming signal and converting the incoming signal into an incoming bit-stream; a DV demuxer directly connected to the interface module for receiving the incoming bit-stream, wherein the DV demuxer de-multiplexes received blocks in the incoming bit-stream into at least video blocks being in video sections and audio blocks being in audio sections; and memory coupled to the DV demuxer for storing the video blocks and audio blocks. By directly connecting the interface module to the DV demuxer, and by not buffering the incoming bit-stream outside the interface module and the DV demuxer, the memory bandwidth requirement of the memory is greatly reduced, and the interface module and the DV demuxer can be easily implemented together in a single IC.

### BACKGROUND OF INVENTION

1. Field of the Invention

The invention relates to multimedia electronics, and more particularly, to a digital video (DV) storage system and a related method of storing DV data received from an interface module in a memory for use by video and audio decoders.

2. Description of the Prior Art

International standard IEEE 1394-1995, “IEEE 1394-1995 Standard For A High Performance Serial Bus,” defines an economical, scalable, high-speed serial bus architecture. This standard provides a universal input/output connection for interconnecting digital devices including, for example, audio-visual equipment and personal computers.

The IEEE 1394-1995 standard supports both asynchronous and isochronous information transfers. Asynchronous transfers are operations that communicate data from a source node to a destination node and take place as soon as permitted after initiation. Isochronous transfers provide information delivery characterized by predictable, bounded latency; guaranteed bandwidth; and on-time data reception. Time intervals between particular events have essentially the same duration at both the transmitting and receiving applications. Isochronous transfer is particularly advantageous in real-time multimedia applications, such as the real-time transfer of digital audio and video data between a digital video camera and a digital television.

FIG. 1 is a block diagram showing an IEEE 1394-1995 isochronous packet 10. The IEEE 1394-1995 standard defines a structured packet into which information is encapsulated for isochronous transfer upon the bus. The IEEE 1394-1995 isochronous packet 10 includes a header field 12; a header cyclic redundancy check (CRC) field 14; a payload data field 16; and a payload data CRC field 18.

The IEEE 1394-1995 standard does not specify particular formats for the contents of the payload data field 16. Rather, the organization of payload data in accordance with a particular format and the interpretation of payload data field contents are functions of the transmitting and receiving applications, respectively. In order to facilitate interoperability between a wide range of digital devices, payload data fields 16 should encapsulate data in accordance with a standardized format. One such format that has gained wide acceptance is the Common Isochronous Protocol (CIP).

FIG. 2 is a block diagram showing a CIP packet 20. The CIP packet 20 includes a CIP header field 22 and a CIP data field 28. The CIP header field 22 spans a first and a second CIP header quadlet 24, 26 (i.e., 8 bytes total), while the CIP data field 28 spans 480 bytes. The CIP header field 22 stores source node identification and timing information, plus parameters that define manners in which the information contained in the CIP data field 28 may be interpreted. For example, the CIP packet sequences could be processed by extracting video data and generating a complete video frame in accordance with a standard format such as Digital Video (DV).

FIG. 3 shows the format of a digital video (DV) frame as received in a DV bit-stream, and FIG. 4 shows the organization of all 150 DIF block 330 in the DV frame of FIG. 3 according to the IEC61938 and SMPTE314 standards. As shown in FIG. 3, each DV frame comprises 120 kilobytes of compressed digital audio and video data, organized as a set of Data in Frame (DIF) sequences 310. In environments supporting the National Television Standards Committee (NTSC) video format, the DV frame 300 includes 10 DIF sequences 310. In Phase Alternating Line (PAL) environments, the DV frame 300 includes 12 DIF sequences 310. Each DIF sequence 310 comprises a header section 312, a subcode section 314, a Video Auxiliary (VAUX) section 316, and an AV data section 318. Taken together, the aforementioned sections 312, 314, 316, 318 occupy 150 DIF blocks 330 organized as shown in FIG. 4. Each DIF block 330 spans 80 bytes, and includes a 3-byte block identification (ID) field 332 followed by a 77-byte data field 334.

FIG. 5 shows a simplified block diagram of a first conventional DV storage system 500. The first conventional DV storage system 500 supports the real-time transfer of digital audio and video data between devices such as a digital video camera and a digital television and includes an IEEE1394 interface 502, a memory 504, and a central processing unit (CPU) 512. A video decoder 514 and an audio decoder 516 are coupled to the DV storage system 500. The IEEE1394 interface 502 receives a stream DATA_IN of IEEE 1394-1995 isochronous packets 10 and stores the contents of each packet's payload data field 16 in a buffer area 506 of the memory 504. Software running on the CPU 512 instructs the CPU 512 to read the data stored in the buffer area 506 and reconstruct the data stored therein in accordance with the DV frame structure shown in FIG. 3 and FIG. 4. The CPU 512 then stores data contained in video DIF blocks 330 of the audio and video section 318 in a video area 508 of the memory 504, and stores data contained in audio DIF blocks 330 of the audio and video section 318 in an audio area 510 of the memory 504. The video decoder 514 reads the data stored in the video area 508 of the memory 504 to reproduce the digital video corresponding to the DV bit-stream received in the incoming stream DATA_IN. The audio decoder 516 reads the data stored in the audio area 510 of the memory 504 to reproduce the audio corresponding to the DV bitstream received in the incoming stream DATA_IN. A problem with the first conventional DV storage system 500 is that a large amount of CPU processing is required.

FIG. 6 shows a simplified block diagram of a second conventional DV storage system 600. The architecture of the second conventional DV storage system 600 is sometimes referred to as pull mode. When using pull mode, the second conventional DV storage system 600 includes the same components connected in the same manner as in the first conventional DV storage system 500; however, in FIG. 6 the software controlled CPU 512 has been replaced with a hardware-based DV Demuxer 602. In this way, the DV Demuxer 602 can be implemented as a part in an integrated circuit, which reduces processing requirements of an onboard CPU (not shown in FIG. 6).

However, when using both the first and second conventional DV storage system 600, a high bandwidth of the memory 504 is required. This high bandwidth is required to facilitate data transfer into the memory 504 by the IEEE1394 interface 502 and the CPU 512 (or the DV Demuxer 602), and out of the memory 504 by the CPU 512 (or the DV Demuxer 602), the video decoder 514, and the audio decoder 516. Additionally, a buffer area 506 is required, which increases the size of the memory by at least 480 bytes (corresponding to the CIP data field 28). Furthermore, both the IEEE1394 interface 502 and the CPU 512 (or the DV Demuxer 602) are implemented in separate ICs, which further increases the design complexity and cost of the DV storage system 500, 600.

### SUMMARY OF INVENTION

One objective of the claimed invention is therefore to provide digital video (DV) storage system having a DV demuxer connected directly to an interface module, to solve the above-mentioned problems.

According to an exemplary embodiment of the claimed invention, a digital video (DV) storage system is disclosed comprising an interface module receiving an incoming signal and converting the incoming signal into an incoming bit-stream; a DV demuxer directly connected to the interface module for receiving the incoming bit-stream, wherein the DV demuxer de-multiplexes received blocks in the incoming bit-stream into at least video blocks being in video sections and audio blocks being in audio sections; and a memory coupled to the DV demuxer for storing the video blocks and audio blocks; wherein the incoming bit-stream is not buffered outside the interface module and the DV demuxer.

According to another exemplary embodiment of the claimed invention, a method is disclosed for storing digital video (DV) data. The method comprises the following steps: providing an interface module for receiving an incoming signal and converting the incoming signal into an incoming bit-stream; directly receiving the incoming bit-stream from the interface module; de-multiplexing received blocks in the incoming bit-stream into at least video blocks being in video sections and audio blocks being in audio sections; and storing the video blocks and audio blocks in a memory.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram showing an IEEE 1394-1995 isochronous packet according to the prior art.

FIG. 2 is a block diagram showing a CIP packet transferred using the IEEE 1394-1995 isochronous packet of FIG. 1.

FIG. 3 shows a digital video (DV) frame transferred using the CIP packet of FIG. 2.

FIG. 4 is a diagram showing the organization of all 150 DIF blocks of FIG. 3.

FIG. 5 is a simplified block diagram of a first conventional DV storage system.

FIG. 6 is a simplified block diagram of a second conventional DV storage system.

FIG. 7 is a block diagram of a digital video (DV) storage system according to an exemplary embodiment of the present invention.

FIG. 8 is a diagram of error counters located in the data extractor of FIG. 7.

FIG. 9 is a block diagram of the buffer manager of FIG. 7.

FIG. 10 is a flowchart describing the operations of the FSM of the data extractor 704a shown in FIG. 8.

FIG. 11 is a flowchart describing the overall operations of the DV demuxer of FIG. 7.

FIG. 12 is a memory map of a video section and an audio section of the memory shown in FIG. 7.

FIG. 13 is a diagram showing a preferred method of writing data into a particular frame N of the memory.

FIG. 14 and FIG. 15 are diagrams showing using different methods of writing data into the memory according to the present invention.

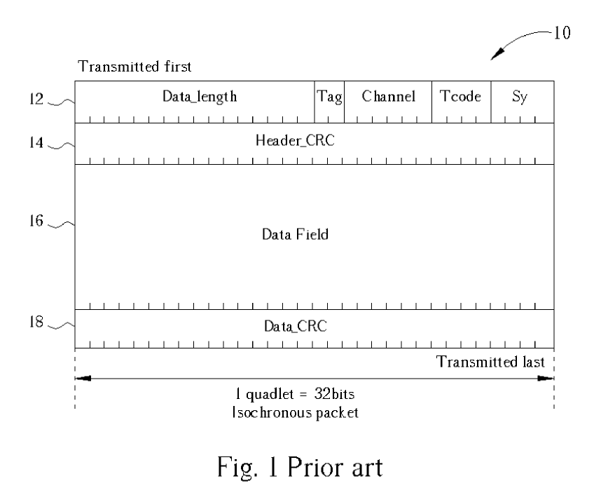

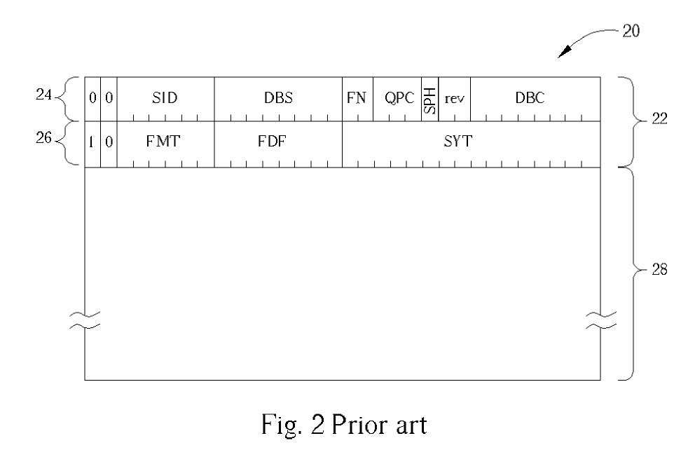

### DETAILED DESCRIPTION

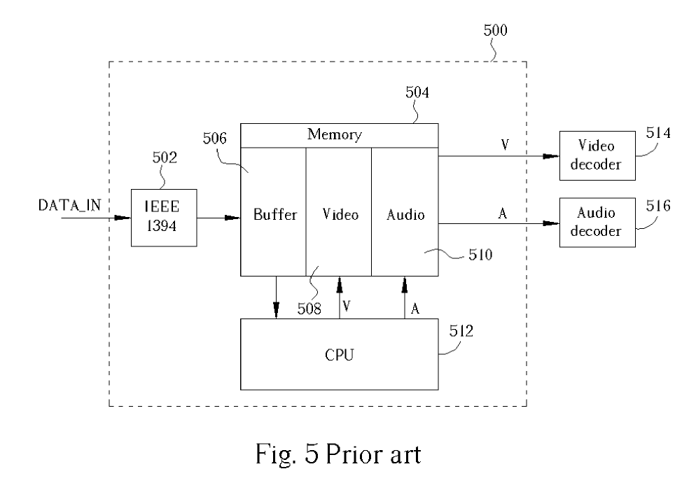

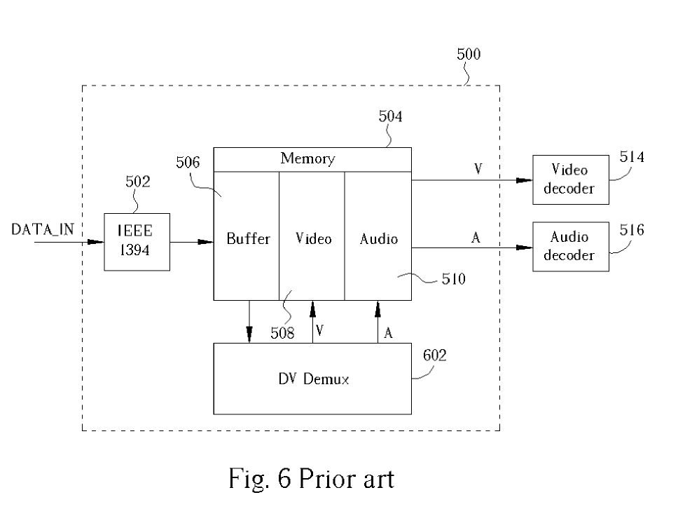

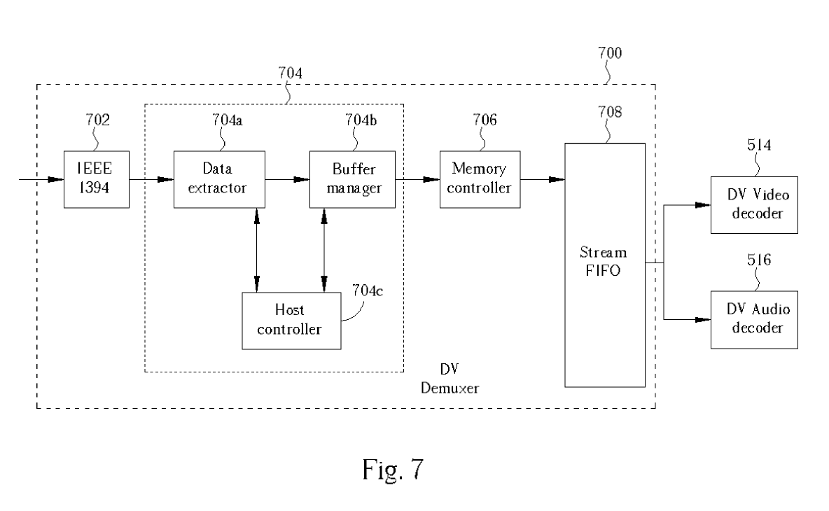

FIG. 7 shows a block diagram of a digital video (DV) storage system 700 according to an exemplary embodiment of the present invention. The DV storage system 700 includes an interface module 702, a DV demuxer 704, a memory controller 706, and a memory 708. As in FIG. 5 and FIG. 6, the video decoder 514 and the audio decoder 516 are coupled to the DV storage system 700. In this embodiment, the interface module is an IEEE 1394 interface module for receiving an incoming signal DATA_IN and converting the incoming signal DATA_IN into an incoming bit-stream DV_DATA. The DV demuxer 704 is directly connected to the interface module 702 for receiving the incoming bit-stream DV_DATA, and the DV demuxer 704 de-multiplexes received DIF blocks 330 in the incoming bit-stream DV_DATA into at least video blocks being in video sections and audio blocks being in audio sections. The memory 708, which in this embodiment is a stream first in first out (FIFO) 702, is coupled to the DV demuxer 702 for storing the video blocks and audio blocks, which are written into the memory 702 by the memory controller 706 under control of the DV demuxer 702. Because the interface module 702 is directly connected to the DV demuxer 704, and because the incoming bit-stream DV_DATA is not buffered outside the interface module 702 and the DV demuxer 706, the bandwidth requirement of the memory 702 is greatly reduced according to the present invention. Additionally, the interface module 702 and the DV demuxer 704 can be easily implemented as a single IC.

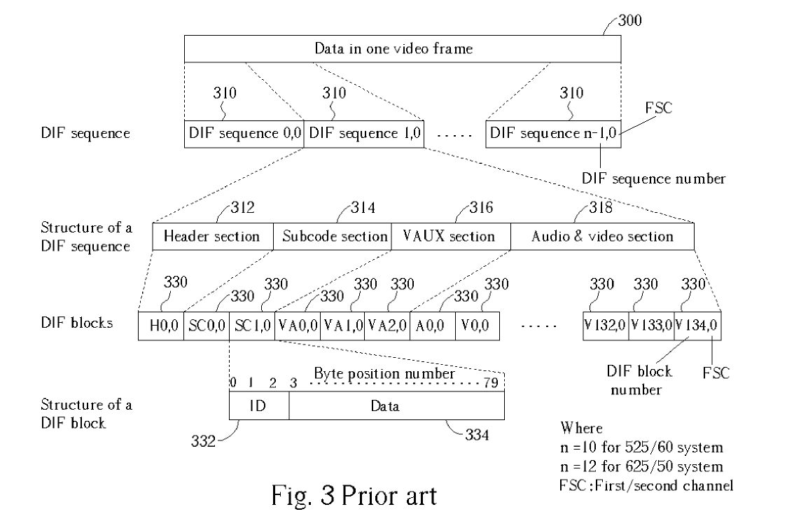

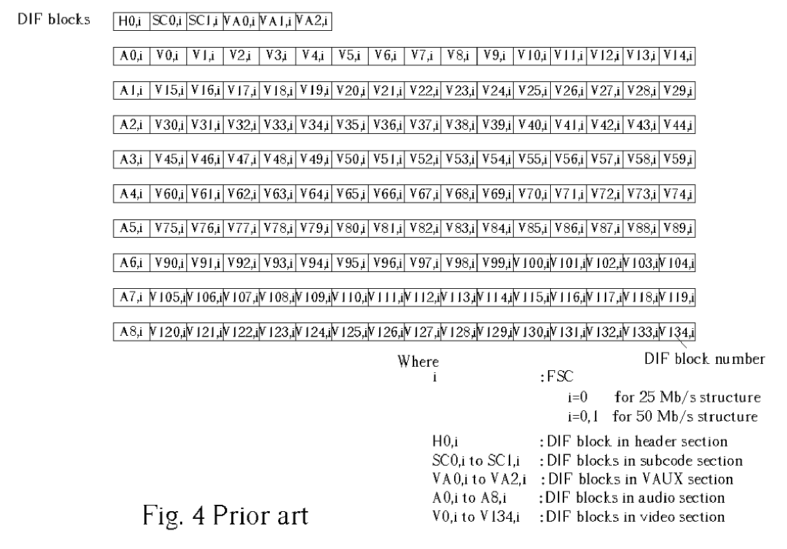

In FIG. 7, the DV demuxer 704 further includes a data extractor 704a, a buffer manager 704b, and a host controller 704c. The data extractor 704a first determines if the incoming bit-stream is compliant with the DV format shown in FIG. 3 and FIG. 4 by receiving the incoming bit-stream DV_DATA and checking the incoming bit-stream DV_DATA for errors to determine if the incoming bit-stream DV_DATA is compliant with the DV format. The data extractor 704a then de-multiplexes the incoming bit-stream DV_DATA into the video and audio blocks.

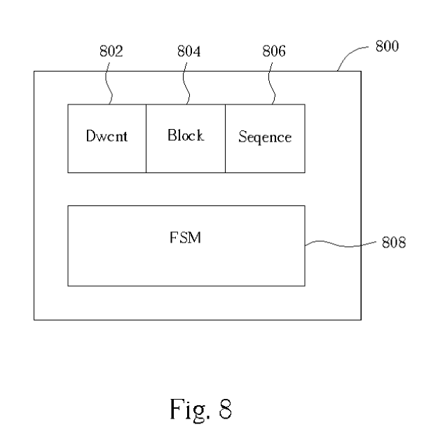

FIG. 8 shows error check counters 800 located in the data extractor 704a. The error counters 800 include a double word counter 802, a block counter 804, and a sequence counter 806 in addition to a finite state machine FSM 808 used to check the accuracy of a plurality of received blocks 300 in the incoming bit-stream DV_DATA. The incoming signal DATA_IN contains CIP packets 20 and the interface module 702 outputs a packet start indication to indicate the beginning of each packet 20 in the incoming bit stream DV_DATA. The data extractor 704a compares the number of double words received in the incoming bit stream DV_DATA starting at the packet start indication with a predetermined value of 120. If the number of double words received in the double word counter 802 exceeds the predetermined value of 120, the data extractor 704a determines the incoming bit-stream DV_DATA to have an error. To further check for errors, the data extractor 704a compares a received block number order of the received blocks 330 in the incoming bit-stream with the predetermined order shown in FIG. 4. If the received block number order differs from the predetermined order shown in FIG. 4 (for example if a particular block number is missing or repeated), the data extractor 704a determines the incoming bit-stream DV_DATA to have an error. Additionally, the data extractor 704a compares a received sequence number order of the received blocks 330 in the incoming bit-stream with the predetermined order shown in FIG. 3. If the received sequence number order differs from the predetermined order (for example if a particular sequence number is missing or repeated), the data extractor 704a determines the incoming bit-stream DV_DATA to have an error.

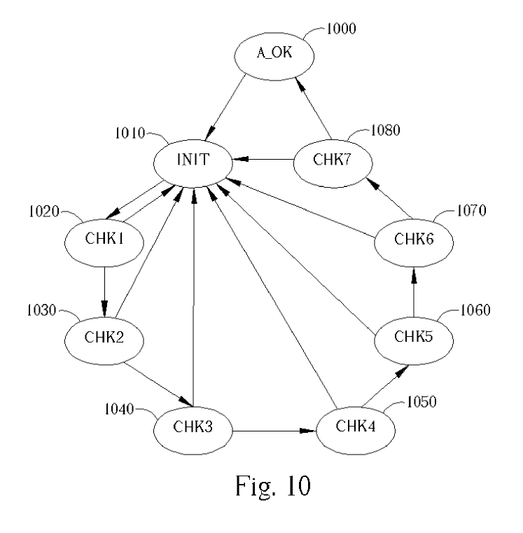

FIG. 10 shows a flowchart describing the operations of the FSM 808 of the data extractor 704a. The FSM 808 is used to determine if the first eight received blocks 330 satisfy the beginning of the frame requirements. The flowchart in FIG. 10 contains the following states:

State 1010: INIT Operations begin in this state. If the DV demuxer received the start flag from IEEE1394, proceed to state 1020; otherwise, remain at state 1010.

State 1020: CHK1 If the next received block 330 in the frame is the [H0] block shown in FIG. 4, proceed to state 1030; otherwise, return to state 1010.

State 1030: CHK2 If the next received block 330 in the frame is the [SC0] block shown in FIG. 4, proceed to state 1040; otherwise, return to state 1010.

State 1040: CHK3 If the next received block 330 in the frame is the [SC1] block shown in FIG. 4, proceed to state 1050; otherwise, return to state 1010.

State 1050: CHK4 If the next received block 330 in the frame is the [VA0] block shown in FIG. 4, proceed to state 1060; otherwise, return to state 1010.

State 1060: CHK5 If the next received block 330 in the frame is the [VA1] block shown in FIG. 4, proceed to state 1070; otherwise, return to state 1010.

State 1070: CHK6 If the next received block 330 in the frame is the [VA2] block shown in FIG. 4, proceed to state 1080; otherwise, return to state 1010.

State 1080: CHK7 If the next received block 330 in the frame is the [A0] block shown in FIG. 4, proceed to state 1000; otherwise, return to state 1010.

State 1000: A_OK-If there are no errors detected in the incoming bit-stream DATA_IN by the data extractor 704a using the above-described double word counter 802, block counter 804, and sequence counter 806, remain at state 1000; otherwise, if any errors are detected, return to state 1010. State 1000 indicates that the data received in the received data-stream DV_DATA is valid.

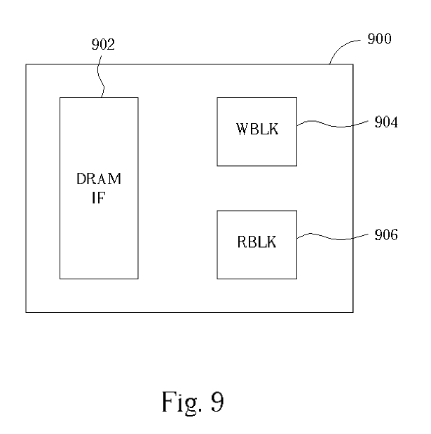

FIG. 9 shows a block diagram 900 of the buffer manager 704b. As shown, the buffer manager 704b has a memory (such as a DRAM) interface 902, which is coupled to the memory 708; a write block pointer 904; and a read block pointer 906. The buffer manager 704b stores the video and audio blocks de-multiplexed by the data extractor 704a in the memory 702 using the memory interface 902 according to the write block pointer 904. The read block pointer 906 is used to read data out of the memory 702 and then provide the data to the video decoder 514 and the audio decoder 516.

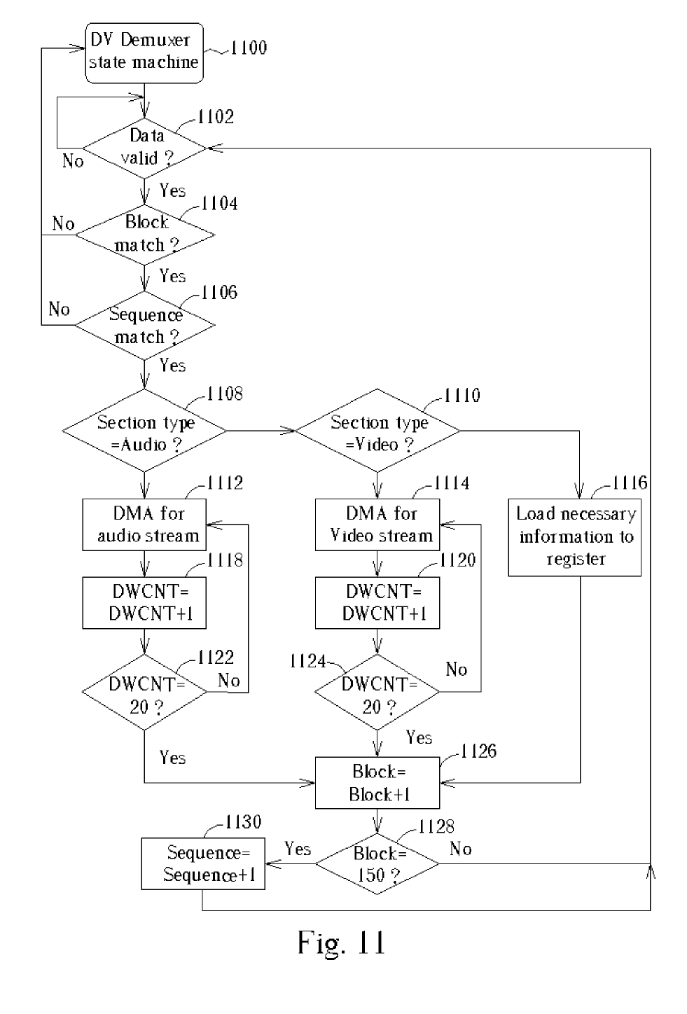

FIG. 11 shows a flowchart describing the overall operations of the DV demuxer 704 described above. The flowchart contains the following steps:

Step 1100: Start DV Demuxer 704 operations.

Step 1102: Did the FSM 808 reach the A_OK (state 1000), which indicates that the received data is valid? If yes, proceed to step 1104; otherwise, remain at step 1102.

Step 1104: Does the block counter 804 match the block number of the currently received block 330? If yes, proceed to step 1106; otherwise, return to step 1100.

Step 1106: Does the sequence counter 806 match the sequence number of the currently received block 330? If yes, proceed to step 1108; otherwise, return to step 1100.

Step 1108: Is the current section an audio section? If yes, proceed to step 1112; otherwise, proceed to step 1110.

Step 1110: Is the current section a video section? If yes, proceed to step 1114; otherwise, proceed to step 1116.

Step 1112: Perform a direct memory access (DMA) data transfer to store a double word of the data of the received block 330 in the memory 702. Proceed to step 1118.

Step 1114: Perform a direct memory access (DMA) data transfer to store a double word of the data of the received block 330 in the memory 702. Proceed to step 1120.

Step 1116: The current received block 330 is a control block so load necessary information contained in the control block to appropriate register(s) in the host controller 704c. Then, proceed to step 1126.

Step 1118: Increment the double word counter 802 and proceed to step 1122.

Step 1120: Increment the double word counter 802 and proceed to step 1124.

Step 1122: Is the double word counter 802 equal to a value of 20? If yes, proceed to step 1126; otherwise, continue storing data by returning to step 1112.

Step 1124: Is the double word counter 802 equal to a value of 20? If yes, proceed to step 1126; otherwise, continue storing data by returning to step 1114.

Step 1126: Increment the block counter 804 and proceed to step 1128.

Step 1128: Is the block counter 804 equal to a value of 150? If yes, proceed to step 1130; otherwise, continue receiving the next block by returning to step 1102.

Step 1130: Increment the sequence counter 806 and return to step 1102.

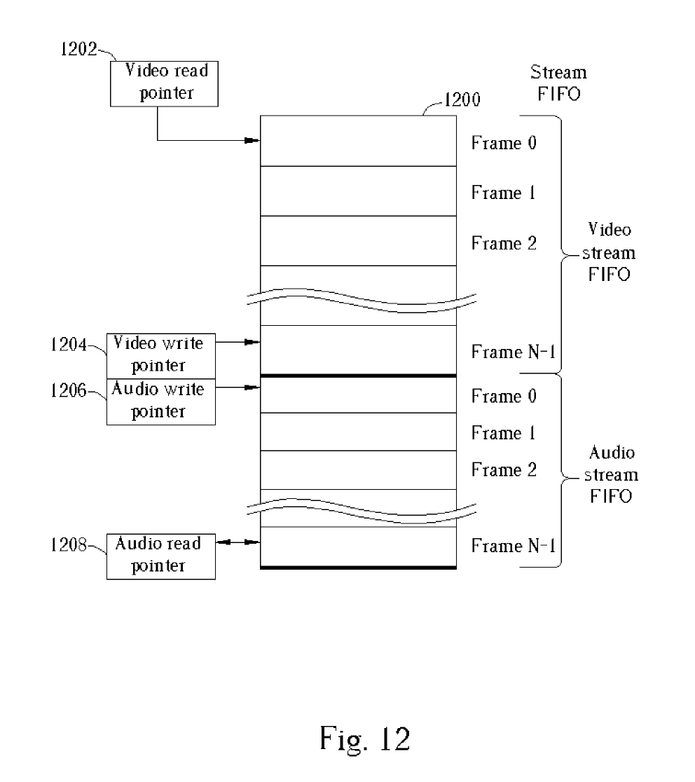

FIG. 12 shows a memory map of a video section (Video Steam FIFO) and an audio section (Audio Stream FIFO) of the memory 708. The memory 708 is implemented as two stream FIFOs: the video stream FIFO and the audio stream FIFO. By using the write pointer 904 as the video read pointer 1204 and the audio write pointer 1206, and by using the read pointer 906 as the video read pointer 1202 and the audio read pointer 1208, pointer management of the memory 708 is easily performed according to the present invention. In this situation, the read pointer 906 and the write pointer 904 are used to indicate frames in each the audio section and video section of the memory 704.

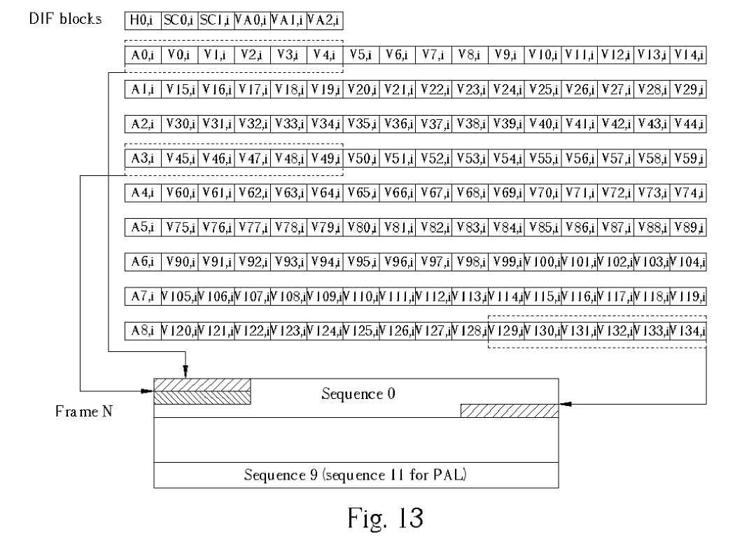

FIG. 13 shows a preferred method of writing data into a particular frame N of the memory 708. Because the order of the received blocks 330 is known to be as shown in FIG. 4, the 3-byte block identification (ID) field 332 each received block 330 can be mapped to an address within the particular frame N in the memory 708. In this way, even if an error occurs, the error is prevented from propagating in the memory 708. Each received block 330 is written into the correct position in the frame. If an error occurs in a block 330, that block 330 will not be written to the memory 708, however, this will not affect the writing of any other blocks 330 to the memory 708, which will be directly written to memory using the address within the particular frame N of the correct section corresponding to the 3-byte block identification (ID) field 332 received in each received block 330.

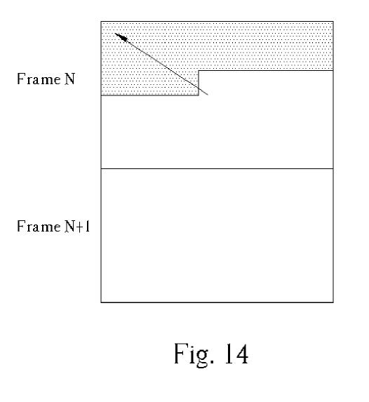

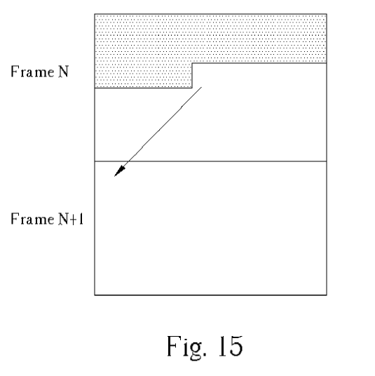

As shown in FIG. 14 and FIG. 15, other embodiments using different methods of writing data into the memory 708 are also possible according to the present invention. For example, FIG. 14 shows a second method of writing data into a particular frame N of the memory 708. In this embodiment, the memory manager 704b sequentially stores the video and audio blocks in respective sections of the memory according to the write block pointer 904. If the data extractor 704a determines the incoming bit stream DV_DATA to have an error, the memory manger 704b returns to the beginning of the respective sections. As another example, FIG. 15 shows a third method of writing data into a particular frame N of the memory 708. In this embodiment, the memory manager 704b sequentially stores the video and audio blocks in respective sections of the memory 708 according to the write block pointer 904. If the data extractor 704a determines the incoming bit stream DV_DATA to have an error, the memory manger 704b increments the write block pointer 904 and skips to the beginning of the respective sections according to the incremented write block pointer 904. In other words, the memory manager 704b skips to the next frame when an error occurs. Both the methods shown in FIG. 14 and FIG. 15 also prevent error propagation within the memory 708.

The present invention discloses a digital video (DV) storage system 700 and a related method of storing DV data. The DV storage system 700 includes an interface module which receives an incoming signal DATA_IN and converts the incoming signal DATA_IN into an incoming bit-stream DV_DATA. A DV demuxer 704 is directly connected to the interface module 702 for receiving the incoming bit-stream DV_DATA, and de-multiplexing received DIF blocks 330 in the incoming bit-stream DV_DATA into at least video blocks being in video sections and audio blocks being in audio sections. These video and audio blocks are then written to a memory 708. By directly connecting the interface module 702 to the DV demuxer 704, and by not buffering the incoming bit-stream DV_DATA outside the interface module 702 and the DV demuxer 706, the memory bandwidth requirement of the memory 702 is greatly reduced according to the present invention. Additionally, the interface module 702 and the DV demuxer 704 can be easily implemented as a single IC, which simplifies the design and reduces processing requirements of an onboard CPU, and lowers the overall cost of the DV storage system.

Those skilled in the art will readily observe that numerous modifications and alterations of the device may be made while retaining the teachings of the invention. Accordinly, the above disclosure should be construed as limited only by the metes and bounds of the appended claims.

What is claimed is:

1. A digital video (DV) storage system comprising:
an interface module receiving an incoming signal and converting the incoming signal into an incoming bit-stream;
a DV demuxer directly connected to the interface module for receiving the incoming bit-stream, wherein the DV demuxer de-multiplexes received blocks in the incoming bit-stream into at least video blocks being in video sections and audio blocks being in audio sections; and
a memory coupled to the DV demuxer for storing the video blocks and audio blocks;
wherein the incoming bit-stream is not buffered outside the interface module and the DV demuxer.

2. The DV storage system of claim 1, wherein the interface module is an IEEE 1394 interface module.

3. The DV storage system of claim 1, wherein the DV demuxer further manages a write block pointer and determines if the incoming bit-stream is compliant with a DV format.

4. The DV storage system of claim 3, wherein the DV demuxer comprises:
a data extractor receiving the incoming bit-stream and checking the incoming bit-stream for errors to determine if the incoming bit-stream is compliant with the DV format before de-multiplexing the incoming bit-stream into the video and audio blocks; and
a buffer manager having a memory interface coupled to the memory, the buffer manager storing the video and audio blocks in the memory using the memory interface according to the write block pointer.

5. The DV storage system of claim 4, wherein the DV demuxer comprises a host controller, and the data extractor outputs received blocks of sections other than the video and audio sections to the host controller.

6. The DV storage system of claim 4, wherein the incoming signal contains packets and the interface module outputs a packet start indication to indicate the beginning of each packet in the incoming bit stream; and the data extractor compares the number of double words received in the incoming bit stream starting at the packet start indication with a first predetermined value, the data extractor determining the incoming bit-stream to have an error if the number of double words received exceeds the first predetermined value.

7. The DV storage system of claim 4, wherein the data extractor compares a received block number order of the received blocks in the incoming bit-stream with a predetermined order, the data extractor determining the incoming bit-stream to have an error if the received block number order differs from the predetermined order.

8. The DV storage system of claim 4, wherein the data extractor compares a received sequence number order of the received blocks in the incoming bit-stream with a predetermined order, the data extractor determining the incoming bit-stream to have an error if the received sequence number order differs from the predetermined order.

9. The DV storage system of claim 4, wherein the memory manager sequentially stores the video and audio blocks in respective sections of the memory according to the write block pointer;
wherein if the data extractor determines the incoming bit stream to have an error, the memory manger returns to the beginning of the respective sections.

10. The DV storage system of claim 4, wherein the memory manager sequentially stores the video and audio blocks in respective sections of the memory according to the write block pointer;
wherein if the data extractor determines the incoming bit stream to have an error, the memory manger increments the write block pointer and skips to the beginning of the respective sections according to the incremented write block pointer.

11. The DV storage system of claim 4, wherein the memory manager stores the video and audio blocks in respective sections of the memory, the respective sections of the memory being determined according to the write block pointer; the video and audio blocks being stored within the respective sections according to a sequence number and a block number of each video and audio block in the incoming bit-stream.

12. A method of storing digital video (DV) data, the method comprising the following steps:
providing an interface module for receiving an incoming signal and converting the incoming signal into an incoming bit-stream;
directly receiving the incoming bit-stream from the interface module;
de-multiplexing received blocks in the incoming bit-stream into at least video blocks being in video sections and audio blocks being in audio sections; and
storing the video blocks and audio blocks in a memory.

13. The method of claim 12, wherein the interface module is an IEEE 1394 interface module.

14. The method of claim 12, further comprising:
determining if the incoming bit-stream is compliant with a DV format; and
managing a write block pointer;
wherein the step of storing the video blocks and audio blocks in a memory is performed according to the write block pointer.

15. The DV storage system of claim 14, further comprising providing a DV demuxer directly connected to the interface module having no buffer or memory between the interface module and the DV demuxer; wherein the steps of receiving the incoming bit-stream, determining if the incoming bit-stream is compliant with the DV format, de-multiplexing the received blocks in the incoming bitstream into at least the video blocks being in video sections and the audio blocks being in audio sections; and managing the write block pointer are performed by the DV demuxer.

16. The method of claim 14, further comprising providing a DV demuxer directly connected to the interface module; wherein the method further comprises: utilizing the DV demuxer to receive the incoming bit-stream and check the incoming bit-stream for errors to determine if the incoming bit-stream is compliant with the DV format before de-multiplexing the incoming bit-stream into the video and audio blocks; and utilizing the DV demuxer to store the video and audio blocks in the memory using a memory interface according to the write block pointer.

17. The method of claim 16, further comprising providing a host controller; wherein the method further comprises outputting received blocks of sections other than the video and audio sections to the host controller.

18. The method of claim 16, wherein the incoming signal contains packets and the interface module outputs a packet start indication to indicate the beginning of each packet in the incoming bit stream; the method further comprising:
utilizing the DV demuxer to compare the number of double words received in the incoming bit stream starting at the packet start indication with a first predetermined value, and determining the incoming bit-stream to have an error if the number of double words received exceeds the first predetermined value.

19. The method of claim 16, further comprising utilizing the DV demuxer to compare a received block number order of the received blocks in the incoming bit-stream with a predetermined order, and determining the incoming bit-stream to have an error if the received block number order differs from the predetermined order.

20. The method of claim 16, further comprising utilizing the DV demuxer to compare a received sequence number order of the received blocks in the incoming bitstream with a predetermined order, and determining the incoming bit-stream to have an error if the received sequence number order differs from the predetermined order.

21. The method of claim 16, further comprising:
sequentially storing the video and audio blocks in respective sections of the memory according to the write block pointer; and
if the data extractor determines the incoming bit stream to have an error, returning to the beginning of the respective sections of the memory.

22. The method of claim 16, further comprising:
sequentially stores the video and audio blocks in respective sections of the memory according to the write block pointer; and
if the data extractor determines the incoming bit stream to have an error, incrementing the write block pointer and skipping to the beginning of the respective sections according to the incremented write block pointer.

23. The method of claim 16, further comprising:
storing the video and audio blocks in respective sections of the memory, the respective sections of the memory being determined according to the write block pointer; and
storing the video and audio blocks within the respective sections according to a sequence number and a block number of each video and audio block in the incoming bit-stream.
